(19) United States
(12) Patent Application Publication
(10) Pub. No.: US 2003/0038779 A1
(43) Pub. Date: Feb. 27, 2003

(54) Acceleration-responsive navigation among mode variables

(76) Inventors: John M. Baron, Longmont, CO (US); Beth M.P. Delaney, Loveland, CO (US)

Correspondence Address: HEWLETT-PACKARD COMPANY, Intellectual Property Administration, P.O. Box 272400, Fort Collins, CO, 80527-2400, US

(21) Appl. No.: 09/935,249

(22) Filed: Aug. 22, 2001

(51) Int. Cl. G09G 5/08

(52) U.S. Cl. 345/157

(57) ABSTRACT

An image capturing device includes at least one acceleration sensor, a display that includes a graphical selection indicator, such as a cursor, and a processor. The at least one acceleration sensor detects an acceleration along at least one axis of the image capturing device and generates an acceleration signal. The processor receives the acceleration signal and moves the graphical selection indicator in response to the acceleration signal.

### FIELD OF THE INVENTION

The present invention relates generally to navigation among displayed mode variables in an image capturing device, and more particularly to an acceleration-responsive navigation among displayed mode variables.

### BACKGROUND OF THE INVENTION

Image capturing devices are used to visually memorialize scenes, events, or items. Image capturing devices, such as analog and digital cameras, include a lens, a shutter, and film or an electronic image sensor. In addition, most modern cameras include a processor and/or other control electronics that function to control shutter speed, aperture, flash, focus, etc.

The various camera functions may be controlled by a user. Most image capturing devices can perform multiple functions and include multiple mode variables that control image capture. For example, a setting may include particular values or on/off states for focus, distance, flash level, flash on/off, image resolution, etc. The user may make selections from among these mode variables based on the ambient photographic conditions and based on personal preferences. Because of the large variations in settings, lighting, etc., users may want and need flexibility in an image capturing device. Consequently, even highly automated cameras typically allow a user to change mode variables.

A prior art image capturing device typically includes buttons or other mechanical input devices that the user may employ to not only capture an image, but to change device configuration settings. This may include navigation among displayed menus. In the prior art, the user may select among mode variables by pressing one or more buttons. The buttons, such as up/down keys and left/right keys, allow the user to move a cursor or other selection indicator and to highlight or designate a desired mode variable. The designated mode variable may then be activated by another button press.

However, a drawback of the prior art is that the user must use one or more fingers in order to first navigate to a desired mode variable and then to select the indicated mode variable. This may be difficult in cold weather, such as when the user is wearing gloves or other forms of hand protection. In addition, navigation among displayed mode variables using buttons or switches includes common drawbacks associated with mechanical input devices. Mechanical input devices are subject to dirt and wear, and therefore their performance may deteriorate over time. They admit moisture and typically corrode. Furthermore, they take up space on the exterior surface of the image capturing device.

Therefore, there remains a need in the art for improvements in navigation among displayed mode variables in an image capturing device.

### SUMMARY OF THE INVENTION

An image capturing device comprises at least one acceleration sensor, a display that includes a graphical selection device, and a processor. The at least one acceleration sensor detects acceleration motion of the entire image capturing device along at least one axis and generates an acceleration signal. The processor receives the acceleration signal and moves the graphical selection device in response to the acceleration signal. Thus, according to the invention, the user may select from different icons or a display simply by moving the entire imaging device to the left, right, up or down, without having to press any buttons.

### BRIEF DESCRIPTION OF THE DRAWINGS

FIG. 1 is a block diagram of an image capturing device according to one embodiment of the invention;

FIG. 2 shows a user pivoting the image capturing device upwards and back, with the pivoting occurring at the user's wrist;

FIG. 3 shows the user swinging the image capturing device forward and back, similar to a swinging movement of a gate;

FIG. 4 shows the user rolling the image capturing device forward (pointing the lens downward) and rolling it back;

FIG. 5 is a simplified diagram of a display that includes a menu; and

FIG. 6 is a flowchart of an acceleration-responsive navigation method among displayed mode variables according to another embodiment of the invention.

### DETAILED DESCRIPTION

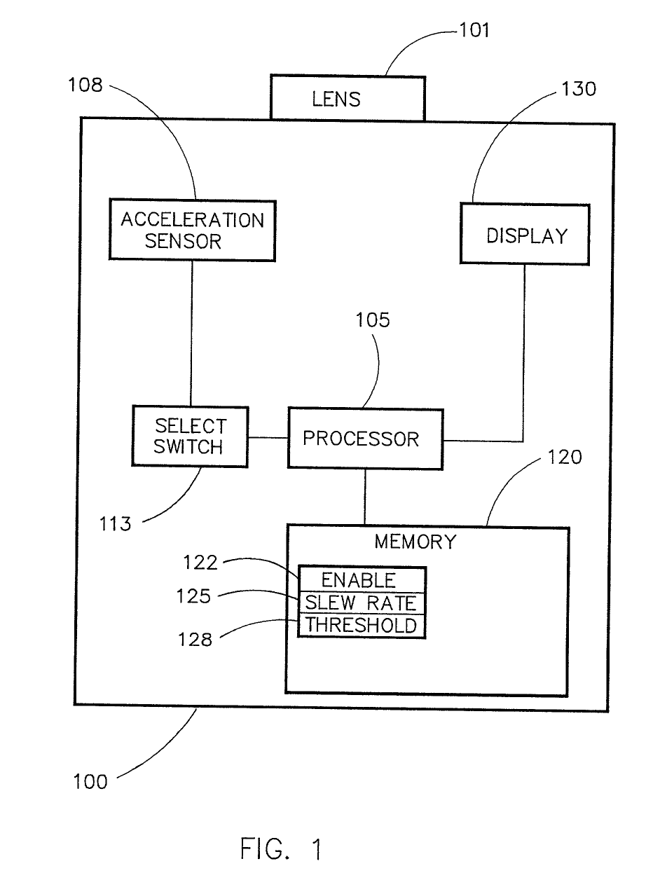

FIG. 1 is a block diagram of an image capturing device 100 according to one embodiment of the invention. The image capturing device 100 includes a lens apparatus 101, a processor 105, at least one acceleration sensor 108, an optional select switch 113, a memory 120, and a display 130.

The processor 105 may be any type of general purpose processor. The processor 105 receives inputs from one or more user input devices and controls overall operation of the image capturing device 100.

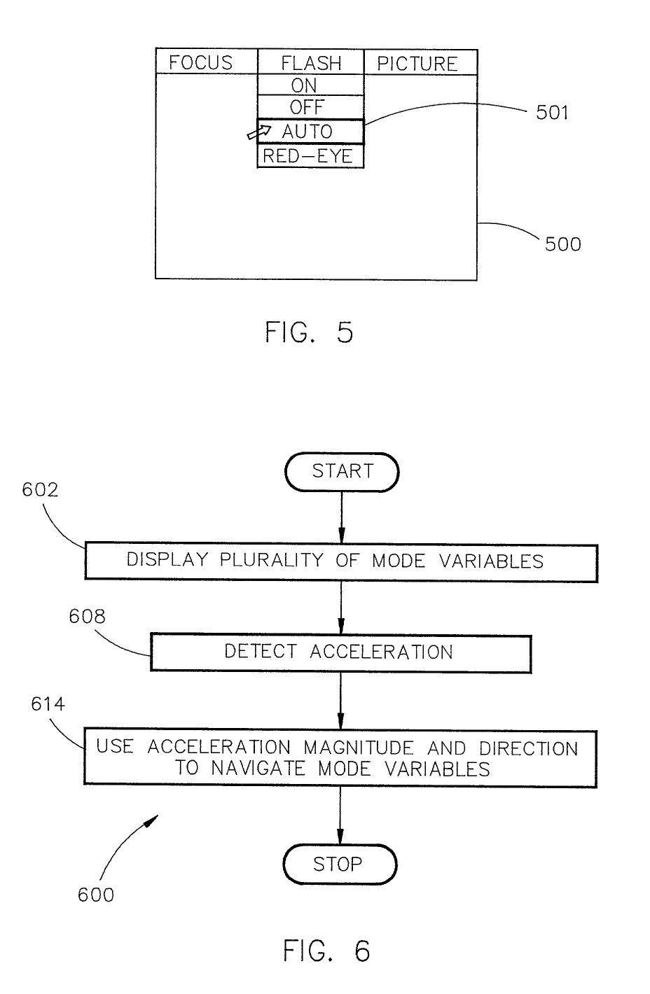

The display 130 may be any type of electronic display device, such as an LCD screen, for example. The display 130 may display menus, lists, tables, etc., among which various mode variables may be chosen (see FIG. 5).

The mode variables are settings that the user can change during operation of the image capturing device 100, such as flash settings, focus settings, image resolution, etc. In addition, a cursor or other graphical selection device may be displayed on the display 130. This may include highlighting or outlining of a mode variable. For clarity the disclosure will refer only to a cursor.

The cursor may be moved in response to user inputs in order to navigate among and select mode variables. The user input may be conventionally received via one or more mechanical input devices, such as one or more buttons.

The at least one acceleration sensor 108 may be any type of sensor capable of detecting gross acceleration along an axis and generating an electrical output in response. The at least one acceleration sensor 108 preferably is capable of detecting a direction and a magnitude of the acceleration, although the acceleration-responsive navigation may be accomplished using only the direction of the detected acceleration. The at least one acceleration sensor 108 may detect acceleration in one, two or three dimensions. The at least one acceleration sensor 108 may detect acceleration from as small as about 0.5 g (gravity) to as large as about 10 g.

The at least one acceleration sensor 108 may comprise multiple acceleration sensors aligned along different axes. For example, the image capturing device 100 may include three acceleration sensors 108, with each acceleration sensor 108 being aligned with one of the orthogonal Cartesian axes (i.e., an x-axis sensor, a y-axis sensor, and a z-axis sensor). In this embodiment, assuming one of the axes is aligned with the lens axis, the image capturing device 100 may detect left-right, up-down, and forward-backward motions and accelerations. Alternatively, the at least one acceleration sensor 108 may comprise an angular motion, acceleration, or force sensor capable of detecting an angular displacement of the image capturing device 100.

In addition to detecting accelerations along a camera axis, the acceleration-responsive navigation of the invention may detect and respond to pivoting motions (i.e., non-linear accelerations). Detection of these non-linear accelerations may be based on the outputs of one or more acceleration sensors, as opposed to linear detection using a single acceleration sensor.

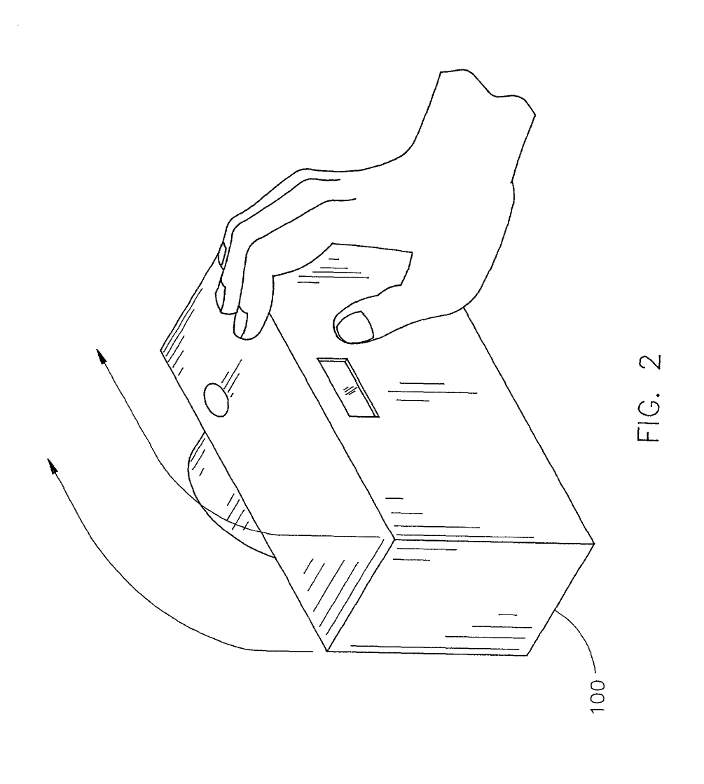

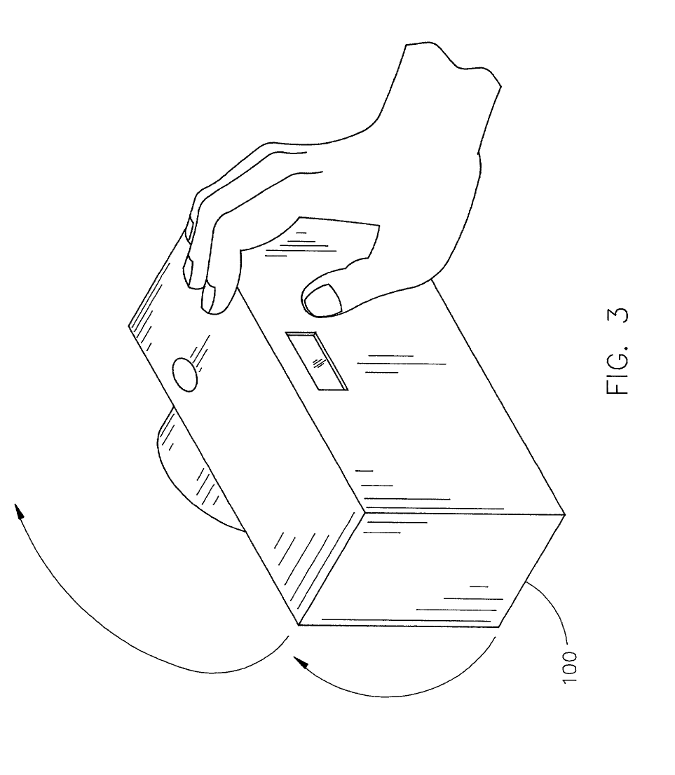

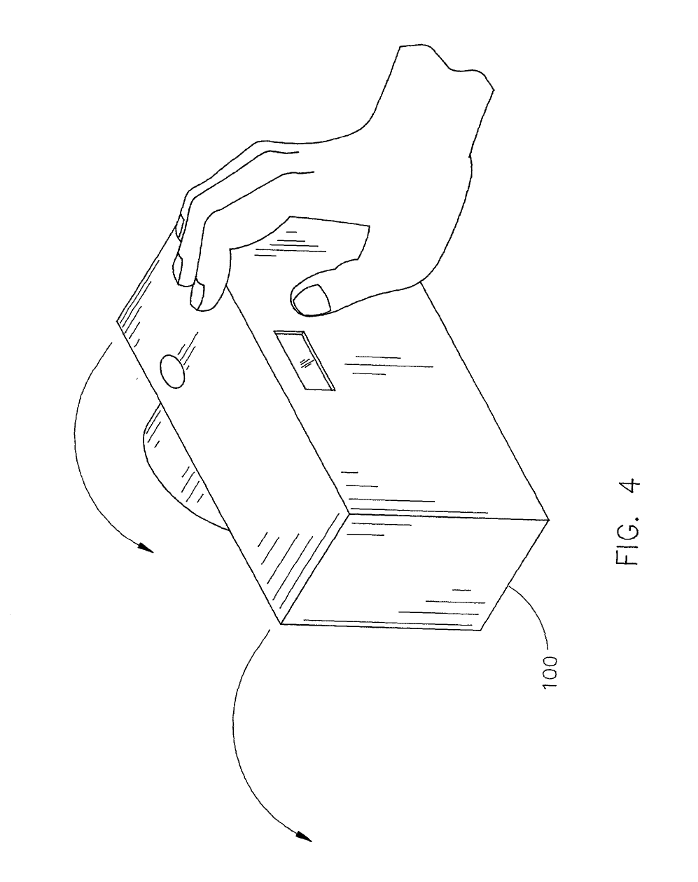

FIG. 2 shows the user vertically pivoting the image capturing device 100 upwards and back, with the pivoting occurring at the user's wrist. FIG. 3 shows the user horizontally pivoting the image capturing device 100 forward and back, similar to a swinging movement of a gate. FIG. 4 shows the user horizontally rolling the image capturing device 100 forward (pointing the lens downward) and rolling it back. Each of these motions may return the image capturing device 100 to a neutral starting position. Each of these motions and accelerations may be detected and used for cursor navigation and mode variable selection.

The at least one acceleration sensor 108 may be a 3-axis accelerometer formed as a chip, such as an airbag sensor available from Fuji Electric Co., Japan. In such an embodiment, selection of a mode variable may be accomplished by moving the device in two predetermined motions in order to move the cursor right or left and up or down and therefore to highlight the desired mode variable on the display. Actuation of the selected mode variable may be executed by moving the device according to a third predetermined motion.

In another alternative embodiment, the image capturing device 100 may use less than three acceleration sensors. For example, the image capturing device 100 may employ only two acceleration sensors 108 that detect accelerations in two directions. The actuation operation may then be performed through a conventional mechanical input device. Furthermore, the image capturing device 100 may employ only one acceleration sensor 108, such as for navigating through a menu bar, for example.

The memory 120 may be any type of memory, including all types of random access memory (RAM), read-only memory (ROM), flash memory, magnetic storage media such as magnetic disc, tape, etc., or optical or bubble memory. The memory 120 may store, among other things, an optional enable variable 122, a slew rate variable 125, and an optional predetermined threshold 128. In addition, the memory 120 may store a software program to be executed by the processor 105.

The slew rate variable 125 may control the amount of movement of the cursor in relation to a detected magnitude of acceleration. Therefore the slew rate variable 125 may control how fast and how far the cursor may move. For example, for a predetermined magnitude of acceleration, the slew rate variable 125 may translate the detected acceleration into one increment of cursor travel on the display 130.

In operation, when acceleration of the image capturing device 100 is detected, the processor 105 uses the direction (and possibly the magnitude) of the detected acceleration in order to move the cursor among the displayed mode variables (assuming the acceleration-responsive navigation is enabled).

For example, by pivoting the image capturing device 100 upward and back to a substantially level position, as shown in FIG. 2 (assuming the user is holding it in a conventional manner), the cursor may be moved to the right in response. Correspondingly, if the image capturing device 100 is pivoted downward and back to a substantially level position, the cursor may be moved to the left in response.

It should be understood that the movements of the image capturing device 100 and the corresponding cursor movements are given for illustration. In implementation, the camera designer may choose among various possible motions for each responsive movement or action of the cursor.

The movement of the cursor may be limited to one increment, such as one row or column of the display 130, for example. The repetition of the cursor movement may be determined by the slew rate value in the slew rate storage 125. For example, the cursor may be incremented every 200 milliseconds of detected acceleration, regardless of the magnitude of the detected acceleration. The slew rate value may be user settable, such as by a dedicated knob or button, through a menu entry, etc.

In one embodiment, the processor 105 may monitor the output of the at least one acceleration sensor 108 and may determine an acceleration duration. The acceleration duration may be used to determine an amount of cursor movement. The cursor may be moved one increment for each predetermined time period in which acceleration is detected.

The image capturing device 100 may optionally include a select switch 113. The select switch 113 allows the user to enable or disable the acceleration-responsive navigation. In the figure, the select switch 113 is shown as being connected in a manner that allows it to interrupt a signal sent from the at least one acceleration sensor 108 to the processor 105.

Alternatively, the user may toggle the state of an enable variable 122 stored in the memory 120. If the enable variable 122 contains an enable state, the processor 105 uses the output of the at least one acceleration sensor 108. Conversely, if the enable variable 122 contains a disable state, the processor 105 ignores the output of the at least one acceleration sensor 108.

It should be noted that other configurations may be employed that allow the user to enable or disable the acceleration-responsive navigation capability. These other configurations also fall within the scope of the invention. One alternative embodiment may include controlling electrical power supplied to the at least one acceleration sensor 108.

FIG. 5 is a simplified diagram of a display 500 that includes a menu 501. It should be understood that the acceleration-responsive navigation according to the invention may also be used with other data display structures, such as lists or tables of mode values, etc. The display 500 may be implemented as a display screen on the back of the image capturing device 100, for example. The menu 501 may display multiple modes across the top, with each mode including a plurality of mode variables extending downward from each mode entry. Thus, for example, the user may move the image capturing device 100 in a first motion in order to move the cursor over the “flash” mode, for example. When the “flash” mode is highlighted, a drop down menu appears as shown. The user may then move the image capturing device 100 in a second motion in order to move the cursor down to the “auto” mode variable beneath the “flash” mode entry. The user may then select the “auto” mode variable by pressing a mode or selection button, or by moving the image capturing device 100 in a third motion in order to select the mode variable (if the image capturing device 100 is capable of detecting the third motion).

FIG. 6 is a flowchart 600 of an acceleration-responsive navigation method among displayed mode variables according to another embodiment of the invention. In step 602, a plurality of mode variables are displayed. This may be in the form of a menu, a list, a table, etc. The plurality of mode variables are settings that the user can change during operation of the image capturing device 100.

In step 608, an acceleration of the image capturing device 100 is detected. The acceleration may be detected through one or more acceleration sensors. For example, three orthogonally oriented acceleration sensors may detect vertical (up-down), horizontal (left-right), and forward-backward accelerations of the image capturing device 100. A direction of the acceleration is detected, and optionally a magnitude and duration of the acceleration may be detected.

In step 614, the detected direction and magnitude are used to navigate among the displayed mode variables. Therefore the image capturing device 100 may be moved upward, downward, left, or right in order to correspondingly move the cursor. As a result of the acceleration detection, the cursor is moved relative to the displayed mode variables. The user may then select a mode variable.

If the image capturing device 100 includes an optional forward-backward acceleration sensor element, the user may select a mode variable by merely moving the image capturing device 100 forward or backwards, as opposed to pressing a separate input button to select the highlighted or indicated mode variable.

The acceleration-responsive navigation of the invention offers several advantages. For example, the user may manipulate and re-configure the image capturing device 100 while wearing gloves, mittens, etc. Furthermore, the user can navigate among mode variables without having to press multiple buttons. The user may be able to change mode variables without necessarily having to look at the displayed variables, and therefore may be able to use the image capturing device 100 in a picture-taking session without pausing. In addition, fewer parts are required, and the acceleration sensor is unlikely to break due to dirt, moisture, or wear since it is mounted inside the housing of the device. Furthermore, there will be less surface area occupied on the exterior of the image capturing device 100.

We claim:

1. An image capturing device, comprising:
at least one acceleration sensor capable of detecting an acceleration motion of said device along at least one axis and generating an acceleration signal in response;
a display that includes a graphical selection indicator that is capable of being moved in said display to select from among a plurality of displayed icons;
a processor communicating with said at least one acceleration sensor and said display;
wherein said processor receives said acceleration signal and moves said graphical selection indicator in response to said acceleration signal.

2. The device of claim 1, wherein said device further comprises three acceleration sensors, with each sensor being positioned along a unique axis of three substantially orthogonal axes.

3. The device of claim 1, wherein said at least one acceleration sensor comprises a three-axis acceleration sensor.

4. The device of claim 1, further including a memory communicating with said processor and storing a predetermined threshold and said graphical selection indicator is moved in response to said acceleration signal only if said acceleration signal exceeds said predetermined threshold.

5. The device of claim 1, further including a memory communicating with said processor and storing a user-adjustable predetermined threshold and said graphical selection indicator is moved in response to said acceleration signal only if said acceleration signal exceeds said user-adjustable predetermined threshold.

6. The device of claim 1, further including a memory communicating with said processor and storing a slew rate variable, wherein a movement speed of said graphical selection indicator is controlled by said slew rate.

7. The device of claim 1, further including a memory communicating with said processor and storing an enable variable, wherein said processor moves said graphical selection indicator in response to said acceleration signal only if said enable variable is set to an enable state.

8. The device of claim 1, further comprising a select switch, wherein said processor moves said graphical selection indicator in response to said acceleration signal only if said select switch is set to an enable state.

9. An image capturing device, comprising:
an acceleration sensing means for detecting an acceleration motion of said device along at least one axis and generating an acceleration signal in response;
a display that includes a graphical selection indicator that is capable of being moved in said display to select from among a plurality of displayed icons;
a processor communicating with said display and receiving said acceleration signal; and
a memory communicating with said processor and storing a predetermined threshold and storing a slew rate variable;
wherein said processor moves said graphical selection indicator in response to said acceleration signal if said acceleration signal exceeds said predetermined threshold, and wherein a movement speed of said graphical selection indicator is controlled by said slew rate.

10. The device of claim 9, wherein said predetermined threshold comprises a user-adjustable predetermined threshold.

11. The device of claim 9, with said memory further storing an enable variable, wherein said processor moves said graphical selection indicator in response to said acceleration signal only if said enable variable is set to an enable state.

12. The device of claim 9, further comprising a select switch, wherein said processor moves said graphical selection indicator in response to said acceleration signal only if said select switch is set to an enable state.

13. A navigation method for an image capturing device, comprising the steps of:
displaying a plurality of mode variables;
detecting an acceleration of said image capturing device and generating an acceleration signal in response; and
moving a graphical selection indicator among said plurality of mode variables in response to said acceleration signal.

14. The method of claim 13, wherein the detecting step comprises detecting an acceleration magnitude.

15. The method of claim 13, wherein the detecting step comprises detecting an acceleration direction.

16. The method of claim 13, wherein the detecting step comprises detecting a vertical pivoting motion.

17. The method of claim 13, wherein the detecting step comprises detecting a horizontal pivoting motion.

18. The method of claim 13, wherein the detecting step comprises detecting a horizontal rolling motion.

19. The method of claim 13, wherein the detecting step further comprises detecting accelerations along three substantially orthogonal axes.

20. The method of claim 13, further comprising the steps of:
storing a predetermined threshold;
comparing said acceleration signal to said predetermined threshold; and
moving said graphical selection indicator in response to said acceleration signal only if said acceleration signal exceeds said predetermined threshold.
